(19) United States
(12) Patent Application Publication
(10) Pub. No.: US 2013/0108995 A1
(43) Pub. Date: May 2, 2013

(54) SYSTEM AND METHOD FOR MONITORING AND INFLUENCING BODY POSITION

(71) Applicants: Louis DePasqua, Round Lake Beach, IL (US); Richard A. Craig, Joliet, IL (US); Scott D. Craig, Wheaton, IL (US); Melaney Craig, Joliet, IL (US)

(72) Inventors: Louis DePasqua, Round Lake Beach, IL (US); Richard A. Craig, Joliet, IL (US); Scott D. Craig, Wheaton, IL (US); Melaney Craig, Joliet, IL (US)

(73) Assignee: C&D Research Group LLC.

(21) Appl. No.: 13/286,037

(22) Filed: Oct. 31, 2011

(51) Int. Cl. G09B 19/00

(52) U.S. Cl. 434/236

(57) ABSTRACT

Systems and methods are provided to monitor a user body position and/or influence a user to change and improve body position, without causing the user to wake up. A personal audio output communicator is adapted to be positioned in close proximity to an ear of the user. A motion detector is adapted to attach to the user for generating a motion signal. A stimulus provider is adapted to receive the motion signal from the motion detector and to compare a motion signal value representative of the motion signal to a preset motion value. In response to the comparison, the stimulus provider transmits a user-selected stimulus and/or voice command stimulus to the personal audio output communicator.

### TECHNICAL FIELD

The invention relates generally to systems and methods for influencing a user to change and improve body position. More specifically, the present invention relates to systems and methods for positional monitoring, positional therapy, and therapeutic monitoring.

### BACKGROUND OF THE INVENTION

Body positional monitoring, positional therapy and therapeutic monitoring all play an important role in a wide range of medical conditions including snoring and sleep related breathing disorders. Additionally, they aid in, at least, the reduction of unnecessary sleep treatments, sleep therapy, the prevention of bed sores, wound care and in positional therapies associated with pregnancy.

Snoring affects millions of people world-wide and is known to be responsible for many disrupted nights of sleep for both the snorer and bed partners alike. Snoring can sometimes be an indicator of a much greater medical disorder referred to as upper airway obstructive sleep apnea (OSA). OSA may be a result of the airway becoming narrowed (hypopnea) or blocked (apnea), causing a reduction in airflow and blood oxygen level. These obstructive airflow events can sometimes last seconds to minutes and may occur over 100 times an hour.

Symptoms of obstructive sleep apnea may include daytime fatigue and excessive daytime sleepiness that can lead to accidents. Sleep apnea is also associated with many long-term medical complications if not diagnosed and treated. Examples of these medical complications can range from heart disease, diabetes, high blood pressure, stroke, memory loss, and weight gain. Sleep apnea is a worldwide epidemic costing the government and insurance companies millions of dollars annually.

As is known in the art, when sleeping in the back position (supine), the tongue, soft pallet, and tissue tend to sag in the back of the throat due to the effects of gravity. This tissue sagging can cause both partial airway closure, leading to snoring, respiratory effort related arousals, hypopnea and complete airway obstruction “APNEA”. Studies by doctors at leading sleep research hospitals have proven that patients with positional snoring and positional sleep related breathing disorders can be successfully treated if they stay off their back while sleeping.

Positional findings from a single night polysomnography (PSG) study do not necessarily reflect the natural sleeping position of a patient, as many patients are forced into sleeping in every position. Due to the nature of single night testing, it is significant for a sleep technician to test many possible body positions during a PSG, to determine if sleep related breathing disorders exist in any of the possible sleeping positions. As a result, natural sleeping positions and time spent in those positions are not necessarily determined in a single night of PSG. Additionally, the cost of PSG's limit the ability to monitor patients for more than one night. Therapies are often prescribed to patients based on sleep related breathing events that happen in positions that patients are forced into during PSG that may not occur during natural sleep. Therefore, a device used to monitor patient positionality over time could prevent unnecessary treatment.

The following study is an example of the importance of body positional therapy: “Sleep Position Training as Treatment for Sleep Apnea Syndrome,” performed at Rush Presbyterian St. Luke's Hospital in Chicago, Ill. by Dr Rosalind D. Cartwright and staff. According to this study: “Ten male patients selected as having sleep apnea predominantly of the obstructive type associated with the supine sleep position on their evaluation night were trained for 1 additional night to avoid the back sleep position by wearing a gravity-activated position monitor/alarm on the chest. This device emitted an auditory signal if the patient remained supine for more than 15 s. The number of apneic events was significantly reduced, as were the number of episodes of significant O2 desaturation. While wearing the alarm, the apnea index of seven patients remained within or near normal limits. On a follow-up night, with only instructions to maintain the lateral decubitus posture, five patients remained significantly improved. Sleep position training may be appropriate as a single or interim treatment for a significant number of sleep apnea patients who have position-related obstruction.”

Some examples of known body positional aids to help discourage sleeping in the supine position are a tennis ball sewn to the back of a shirt and a strap-on vest that has large air bladders in the back, making it uncomfortable to sleep in the supine position. These known positional aids are not always effective as users have been known to remove them and continue sleeping in the supine position.

Another form of known body positional therapy includes restricting sleeping positions by placing weights on legs, limbs, ribs, shoulders, and arms. This form of therapy may be used to help the healing process following surgery, to prevent bed sores, or to help heal broken bones. For example, for post-surgery patients, it may be critical to not sleep in certain positions while the healing process occurs for days or sometimes weeks.

Several body positional and snoring inventions have been patented over the years. The following are some examples of prior patents related to snoring and body position:

U.S. Pat. No. 3,089,130 Snore Alarm describes “an automatic awakening device for jarring or shaking a sleeper when he begins to snore.” The '130 system uses a microphone to detect snoring sounds and an electric solenoid, mounted on a bed and connected to a plate under the sleepers pillow, to shake the sleepers pillow.

U.S. Pat. No. 3,696,377 Anti-Snoring Device describes “Vocal sounds of a sleeper above predetermined level sensed by a transducer (microphone) initiate operation of a record player device for delivery of audible anti-snoring or equivalent instructions (stop snoring) to a sleeper.” The '377 system has several limitations, including that it uses a microphone to sense snoring noise. A microphone may capture noises other than the sleeper's snores, including a bed partner's snoring, sleep talking, coughing, and other household noises, and falsely trigger the anti-snoring system based thereon. The '377 device may have a negative effect on the sleeper by waking him up several times a night due to other noises in a room, including their own mild snoring, and does not provide the benefits of body positional therapy.

U.S. Pat. No. 3,998,209 Snoring De-conditioning System and Method is directed to detecting snoring with use of a microphone and awaking the sleeper with aversive reinforcement in the form of electric lamps, pillow buzzer, arm tapping device, vibratory electromagnetic clapper, and a mild electric shock. The awoken sleeper must then reach over and press a button for a preset amount of time to shut off the aversive reinforcement and activate two stimuli in the form of dispensing a candy mint or M&M's. Once the awoken sleeper completes these tasks, a prerecorded message will play through a loudspeaker: “You performed well, you awoke, changed your position, pressed and held the lighted button to remove the annoying stimulations, ate the candy, listened to this message, all to help you to stop snoring. Keep up the good work. Please return to sleep in a new position.” The '209 system has limitations similar to those described above for the '337 patent in that the sleeper is woken up for any noise heard in the room, including their own non-adverse sounds such as throat clearing or mild snoring. Additionally, the '209 system requires the sleeper to press a button to deactivate aversive awakening, thus forcing the sleeper to wake up and get up.

U.S. Pat. No. 4,220,142 Behavioral Shaping Device for Eliminating Nocturnal Sounds describes: “A behavior shaping device is disclosed for eliminating nocturnal sounds, such as snoring. The device comprises the generally well known microphone amplifier and alarm means (buzzer), with the alarm means being activated when the input level is above a predetermined level”. The '142 system also counts and stores the number of the times the alarm was activated to ascertain the progress he is making. The microphone and alarm in the '142 system create limitations similar to those as described above for the '377 and '209 patents.

U.S. Pat. No. 4,617,525 Sleep Posture Monitor and Alarm System describes: “a device for awakening a sleeping person when the sleeping person attempts to sleep in a particular sleep posture includes a time delay circuit and an alarm (electric buzzer) or other device for generating a stimulus for awakening the person.” The '525 patent states: “the sensor comprises a position sensitive switch mounted on the sleeping person's body and actuated by gravity” when the user would sleep on their back. The position sensor switch is also connected to a time cycle time delay circuit that will enable an audio buzzer once the sleeper has been sleeping on their back for a certain length on time. One limitation of the '525 system is that the user will be woken up by a confusing and disorienting electronic buzzer that may cause the user (and their bed partner) to be completely woken into a conscious and alert state. These disruptions by an audible buzzer may lead to many interruptions and sleepless nights.

U.S. Pat. No. 4,644,330 Anti-Snoring Device describes: “A compact self-contained electric anti-snoring device to be worn in the outer ear or attached thereto. It comprises a miniature microphone for detection of snoring sounds for generating an aversive audio signal.” The '330 device has limitations similar to other prior art patents (e.g., '525 patent) in that it discloses an audio microphone to detect snoring, making it susceptible to false audio trigging, and an audio oscillator tone generator as an aversive wake device.

U.S. Pat. No. 4,788,533 Device For Interrupting The Snoring Of A Sleeping Person describes: “A device is provided for interrupting the snoring of the subject as soon as it starts. Said device is comprised of a microphone for picking up the noise emitted by the subject and means for comparing the intensity of the noise picked up by the microphone with a given alarm threshold.” The '533 device is another example of using a microphone to pick up snoring noises and a fixed frequency 2 Khz sound wave stimulus alarm to interrupt the snoring of a sleeping subject. The '533 patent has limitations similar to the '525 patent discussed above.

U.S. Pat. No. 4,848,360 Device For Preventing Of Snoring is directed to using a microphone to detect snoring and logic circuitry to qualify snoring that is know to occur at know periodical time intervals over a known duration of time. The '360 device has been adapted to influence a sleeping person to change his sleeping position with the aid of a vibrator sending out influencing vibrations. The '360 system has limitations as the microphone has issues with false triggering from other outside sounds, causing the user to be fully awoken by the vibrator, and thereby disrupting their sleep.

U.S. Pat. No. 5,038,137 Sleep Posture Monitor And Alarm describes: “A sleep monitor alarm (buzzer) system detects one or more of four possible sleep positions and sounds an alarm when an individual wearing the apparatus assumes one or more positions.” Limitations of the '137 system include the use of a buzzer to influence a sleeper to change their body position, as a buzzer is an annoyance device fully awakening a sleeper in a confusing method, like the other examples above.

U.S. Pat. No. 5,081,447 Keep Off Your Back Alarm describes: “Apparatus for influencing a person to sleep on his side not on his back. A gravity actuated sensor apparatus is attached to a sleeping person for detecting body position and to sound an alarm informing the person when he is resting on his back thereby enticing the person to sleep on one side or the other and not on his back.” The '447 system uses a buzzer alarm to encourage the sleeper to keep off their back and therefore, has similar limitations as several of the patents described above. The use of a buzzer is a very disruptive confusing way to wake up a human, causing a person to wake up completely from a deep sleep.

U.S. Pat. No. 5,477,867 Device For The Suppression Of Snoring describes: “The device has a microphone with a combined amplifier, filter and demodulator for detection of snoring noises. If the sleeper is found to be snoring, a control operates a tone generator, which drives a sound emitter via an amplifier for emitting acoustic signals.” The '867 patent also discloses using a plurality of acoustic signals having differing spectral composition to influence the sleeper to stop snoring. The '867 system has at least the disadvantage of using a microphone that may cause false audio triggering due to other room noises, as stated in the above examples.

U.S. Publication No. 2003/0199943 A1 Device And Method For Treating Disordered Breathing describes “A device is disclosed for treating sleep and breathing dis-orders of a patient, along with the method of using the device. A first sensor is positionable for receiving breathing sound information emitted from either the mouth or nose of a patient. The second sensor is positionable on a patient for receiving breathing sounds information from a patient's chest cavity. A third sensor is positionable for receiving information related to the amount of chest expansion of a patient. A first output device is provided that is capable of providing an auditory signal to a patient.” The '943 device does not detect the sleeping position of the patient.

U.S. Publication No. 2011/0132378 A1 Systems And Methods For Controlling Position describes: “Systems and methods for controlling the position of a wearable positional therapy device are provided. The device can be configured to provide feedback to a user if the user is sleeping or is positioned in a target position to induce the user to change position. The feedback can be provided by one or more haptic motors that can be configured to provide various levels of feedback and the level of feedback can be customized based on the user's reaction to the feed-back.” The '378 application further discloses: “A wearable position therapy device for influencing the position of a user, the system comprising: a position detector configured to generate positional signal data that can be used to determine the position of the user, a haptic (motor) feedback device configured to generate tactile feedback to the user of the device.” The '378 application also discloses an “audiovisual output module that can be used as a means to communicate with the user. In one embodiment, voice messages can be provided via an audio circuit or speaker to provide feedback to the user. For example the, a voice message might be to indicate that the PTD100 has slipped out or has fallen off. In another example, a voice message might be provided to indicate that the battery 155 is low or that the PTD100 is running out of memory for storing data.” Thus, according to the '378 application, voice messages are provided to the user to facilitate the use or technical operation of the device, and not to assist in influencing the sleeping position of the user or apnea therapy.

In sum, prior anti-snoring and sleep therapy solutions teach the use of a microphone to detect snoring sounds, which may be susceptible to false triggering due to other room noises, and an aversive buzzer or alarm to awaken the user and potentially bed partner each time supine positioning is detected, thereby causing the user and probably bed partner to be fully awakened several times a night. The present invention is directed to solving these and other problems.

### SUMMARY OF THE INVENTION

The present invention is defined by the appended claims. This description summarizes some aspects of the present embodiments and should not be used to limit the claims.

To facilitate an understanding of the disclosed invention, some of the physics of human sleep will now be discussed. During sleep, humans may pass through stages 1, 2, 3, and REM (rapid eye movement) of sleep. The stages progress in a cycle from stage 1 to REM and then cycle again, repeating several times a night. During stage 1, the sleeper drifts in and out of sleep and can be woken easily, and the eyes and muscles begin to move very slowly. During stage 2, the eye movement stops and brain waves begin to slow down. During stage 3, the brain continues to slow, showing delta waves. During the REM stage, breathing becomes more rapid, irregular, and shallow; the eyes jerk rapidly; and the limb muscles become temporarily paralyzed. REM is when humans begin to dream. Ideally in healthy sleep, all four cycles take approximately 90 to 110 minutes and repeat several times a night. During sleep, the liver, kidneys, and other organs typically detoxify the accumulation of ingested, internally manufactured, and inhaled toxins. During the REM stage, significant emotional and brain repair occur.

Turning to one embodiment of the present invention, such embodiment is directed to a system and method for providing a body positional monitoring. A personal body positional monitor is adapted to be attached to the user, and includes a motion detector for generating a motion signal associated with a body position of the user. The personal positional monitor can also include a processor, a memory, and program code for receiving signals from the motion detector and for determining and recoding the position of the user while the user is sleeping. This embodiment can be a stand-alone monitor or can be included with other embodiments of the present invention.

Another embodiment of the present invention is directed to a system and method providing a body positional aid to assist with the treatment of snoring, sleep related breathing disorders, and the prevention and treatment of medical conditions related to body position.

In one embodiment, a user is influenced to change and improve body position, without causing the user to wake up. An improved manner of decreasing or eliminating the sound level of the user's snoring is also provided.

In one embodiment, a personal audio output communicator is adapted to be positioned in close proximity to an ear of the user for preventing the audio outputted by the personal audio output communicator from being audible to persons other than the user. A motion detector is adapted to attach to the user for generating a motion signal associated with a body position of the user. A stimulus provider is adapted to receive the motion signal from the motion detector and to compare a motion signal value representative of the motion signal to a preset motion value, the preset motion value being associated with an unwanted change in body position. In response to the comparison, the stimulus provider transmits a user-selected stimulus to the personal audio output communicator for influencing the user to change body position.

According to one embodiment, a method is provided for influencing a user to change and improve body position using an electronic device having a personal audio output communicator, a motion detector, and a stimulus provider. The method includes positioning the personal audio output communicator in close proximity to an ear of the user to prevent the audio outputted by the personal audio output communicator from being audible to persons other than the user. The method also includes generating a motion signal associated with a body position of the user and comparing a motion signal value representative of the motion signal to a preset motion value. The preset motion value is associated with an unwanted change in body position. The method further includes, in response to the comparison, transmitting a user-selected stimulus or voice command stimulus to the personal audio output communicator, the stimulus influencing the user to change body position.

According to one embodiment, an electronic device for influencing a user to change and improve body position is provided. The electronic device includes a personal audio output communicator adapted to be positioned in close proximity to an ear of the user to prevent the audio outputted by the personal audio output communicator from being audible to persons other than the user. The electronic device also includes a stimulus provider adapted to transmit a user-selected stimulus or voice command stimulus to the personal audio output communicator for influencing the user to change body position in response to a detected body motion.

According to one embodiment, a computer for influencing a user to change and improve body position is provided. The computer includes a processor, a motion detector, and a memory. The memory includes a body position influencer application and a database. The processor is in communication with a personal audio output communicator that is positioned in close proximity to an ear of the user for preventing the audio outputted by the personal audio output communicator from being audible to persons other than the user. The body position influencer application is configured to generate a motion signal associated with a body position of the user and compare a motion signal value representative of the motion signal to a preset motion value. The preset motion value is associated with an unwanted change in body position. In response to the comparison, the body position influencer application is configured to transmit a user-selected stimulus and/or voice command stimulus to the personal audio output communicator, the stimulus influencing the user to change body position.

Other systems, methods, articles of manufacture, features, and advantages of the present invention will be, or will become, apparent to one having ordinary skill in the art upon examination of the following drawings and detailed description. It is intended that all such additional systems, methods, articles of manufacture, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a drawing showing different perspective views of an enclosure in accordance with one embodiment of the present invention.

FIG. 2 is a drawing showing the enclosure of FIG. 1 attached to a user according to one embodiment of the present invention.

FIG. 3 shows a schematic diagram of a body position influencer according to one embodiment of the present invention.

FIG. 4 shows a schematic diagram of logic circuitry for a body position influencer having a mechanical gravity tilt switch in accordance with one embodiment of the present invention.

FIG. 5 shows a schematic diagram of logic circuitry for a body position influencer having an electronic accelerometer in accordance with one embodiment of the present invention.

FIG. 6 is a system diagram illustrating a computer-networked system in accordance with an embodiment of the present invention.

FIG. 7 is a schematic diagram of one computer implemented embodiment of the present invention.

FIG. 8 is a flow-chart illustrating a method for influencing body position in accordance with an embodiment of the present invention.

FIG. 9 is a side view of a body position influencer according to one embodiment of the present invention.

### DETAILED DESCRIPTION OF THE INVENTION

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

### 1. General Description

Humans may change their sleeping positions many times a night without even being aware of the change. Changes in body position most frequently occur during stage 1 or stage 2 sleep phase. Ordinarily, the sleeper is completely unaware of the position change. A sleeper may recognize and respond to instructions while in a stage 1 or stage 2 sleep phase, and may be completely unaware of the instructions the next morning. For example, a bed partner may be woken up from the sound of a snoring person sleeping next to them in the supine position. The non-snoring bed partner may then say “RICHARD YOUR SNORING ROLLOVER!”; at which point, the snorer may simply roll over with no recollection of doing so. Snoring is commonly caused by the tongue and soft pallet collapsing in the back of the throat due to gravity, especially when an individual is sleeping on their back. In most cases, the sound level of the snoring may be greatly reduced when the sleeper is lying in the lateral position. For example, the snoring may be reduced to a sound level that is not loud enough not to wake up the bed partner.

One embodiment of the present invention is directed to a system and method for influencing a user to change and improve body position without awakening the user or bed partner. A body position influencer is provided comprising a body-mounted position sensor (also referred to herein as a motion sensor) for detecting a body position of the user and a personal output communicator (such as, for example, an ear phone, headphone, speaker, etc.) for outputting a pre-recorded audio message (also referred to herein as a user-selected stimulus) to the user. The body position influencer also includes a stimulus provider for determining whether the user's body position corresponds to a preset unwanted body position. Upon detection of an unwanted body position, the stimulus provider transmits the user-selected stimulus to the personal audio output communicator. The personal audio output communicator may be positioned in close proximity to an ear of the user to prevent the outputted voice command stimulus from being audible to persons other than the user, such as, for example, the user's bed partner.

A device who's purpose is solely to wake up a user to prevent the user from snoring will prevent the user from sleeping in the first place. As such, one significant goal of the present system and method is to keep the user sleeping or close thereto, and at the same time get the patient to sleep on their side (or at least not on their back), in order to reduce or prevent the snoring while not waking the user.

Snoring decibel sound level is greatly reduced in most cases when sleeping in the lateral position. This position can reduce the snoring level enough not to wake up the bed partner. As such, the present system and method is provided for lessening or eliminating the decibel level of the snoring to a more tolerable level with the aid of this positional treatment device. The present system and method is also provided for use in combination with other well known snoring and sleep apnea therapies. One example would be an oral appliance device that is known to reposition or protrude the lower jaw forward to help open the airway in the throat. In some cases even the oral appliance therapy alone will not be effective if the user sleeps in the supine back position. In this case the combination therapy of the oral appliance used with this invention (positional therapy) can be a significant solution. The present system and method in combination of an oral appliance can also be a significant solution.

The combination of body position in conjunction with verbal voice commands is significant in obtaining successful results using the present embodiment of the system and method. Instead of waking up a bed partner to tell the snorer to roll over, the present system and method uses subliminal (undetected, unnoticed, and/or concealed) voice instruction that will effectively influence a human to sleep in specific positions without awakening the user or bed partner. As mentioned, this system and method uses the combination of body position sensing and digital voice command instruction.

As such, in one embodiment, the body position influencer includes battery operated electronics housed in a compact enclosure with an attachment clip that may be worn by the user in several different configurations, including mounted on the t-shirt collar, headband, or pajama bottoms, or alternatively, attached to an elastic strap that is mounted around the chest area. The enclosure may be clipped to the back of a shirt, only inches away for the user's ear. A headphone output jack may allow the user to connect, for example, a small single in-ear headphone that has a short wire length. The user may pre-record an audio message (for example, “roll over you're snoring”) with a built-in microphone using the voice of their bed partner, their own voice, or any other sound. According to this embodiment, the motion sensor may be an internal gravity tilt switch (also referred to herein as a tilt switch) that is adapted to detect a predetermined tilt in the user's body position corresponding to the supine position. Once the user moves to the supine position, the tilt switch activates a digital voice chip to play the pre-recorded voice command, thus influencing the sleeper to “Roll Over.”

In another embodiment, the motion sensor may be an electronic accelerometer device capable of measuring the earth's gravity in all positions X, Y, and Z. The accelerometer may be connected to a microprocessor that allows for 360 degrees of full body position sensing. According to this embodiment, the user will be able to specify which body position they would like to avoid. The microprocessor utilizes a memory to store multiple recorded voice messages. The microprocessor also may record data related to the sleeping position of the user, for example, at 5 second intervals throughout the night. In addition, the microprocessor may record data related to the duration and number of times the user tries to sleep in the non-desired position. The recorded sleep position data may be used to determine the effectiveness of the body position influencer. The recorded sleep position data may be downloaded to a computer using a USB connection or using a wireless internet connection through a computer or smart phone network. The recorded sleep position data may then be analyzed by physicians or insurance companies for effectiveness and compliance.

One or more embodiments may also be used in combination with other well known snoring and sleep apnea therapies to provide improved results. For example, an oral appliance device is known to reposition or protrude the lower jaw forward to help open the airway in the throat. In some cases, even the oral appliance therapy alone will not be effective if the user sleeps in the supine position. In such cases, the combination of the oral appliance and the body positional therapy of the present invention may be a successful solution.

### 2. Exemplary Embodiments

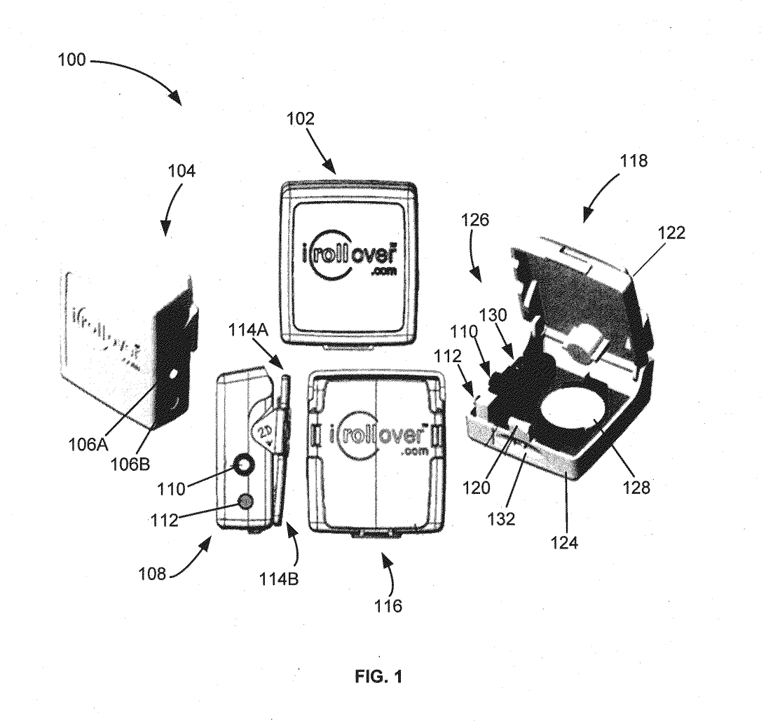

Referring now to FIG. 1, a drawing illustrates five perspective views of an enclosure 100 for a body position influencer in accordance with one embodiment of the present invention. The enclosure 100 may be a plastic casing, or the like. Front view 102 shows a front-facing side of the enclosure 100. Front-side view 104 shows the front-facing enclosure at an angle with openings 106 on the side of the front-facing enclosure being visible. Side view 108 shows a side of the enclosure that corresponds to front-side view 104. In side view 108, openings 106A and 106B are shown as receiving an audio output headphone jack 110 (also referred to herein as an audio output) and a record switch 112. The audio output 110 and the record switch 112 will be discussed in more detail below.

Side view 108 also shows an attachment clip 114 having an upper portion 114A and a lower portion 114B. Attachment clip 114 includes an internal spring that allows for a pivotal action when the upper portion 114A is pressed towards the enclosure 100. The pivotal action moves the lower portion 114B away from the enclosure 100 and the upper portion 114A towards the enclosure 100, creating a gap between the enclosure 100 and the lower portion 114B. The enclosure 100 may be attached to a user's body by inserting a portion of, for example, the user's shirt into this gap and then releasing the attachment clip 114. Alternatively, the attachment clip 114 may be attached to another article of clothing on the user's body, including the user's pants, a vest, a headband, an armband, a wristband, a hat, etc. As another alternative, the attachment clip 114 may be attached to a strap, an elastic band, or any other fastening mechanism for attaching to the user's body. For example, the attachment clip 114 may be attached to an elastic band that is wrapped around the user's chest. Back view 116 shows a back-facing view of the enclosure 100 and includes attachment clip 114.

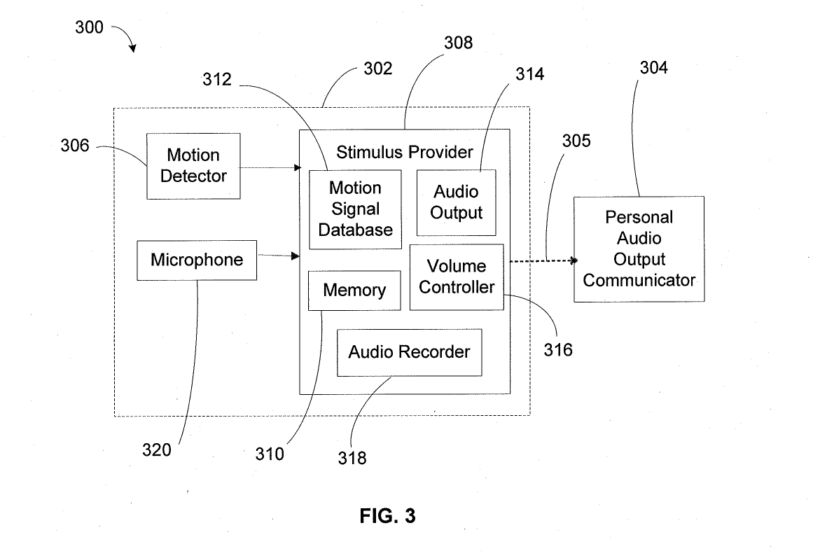

Open view 118 shows the inside of enclosure 100. Enclosure 100 may be opened by pressing on a lower latch 120 and pulling a front side 122 away from a back side 124. Once the enclosure 100 is opened, access may be granted to internal components 126, including a battery 128. The battery 128 may be, for example, a 3 volt lithium CR2032 battery. Internal components 126 also include the audio output 110, the record switch 112, and an internal microphone 130 (as referred to herein as a microphone). The user may press the record switch 112 to activate recording of the personal audio message which may be spoken or played into the microphone 130. The personal audio message may be heard by the user by connecting a headphone (also referred to herein as a personal audio output communicator) (not shown) to the audio output 110. The headphone may be, for example, an in-ear headphone with a 3.5 mm male-ended connector, and the audio output 110 may include a 3.5 mm female-ended connector for receiving the in-ear headphone connector. The internal components 126 may also include a volume trimmer control (also referred to herein as a volume controller) (not shown) for adjusting the playback volume level of the personal audio message. The audio output 110, the microphone 130, the personal audio output communicator, and the volume controller will be discussed in more detail with reference to FIG. 3. Open view 118 also shows a power switch 132 for turning the body position influencer on or off.

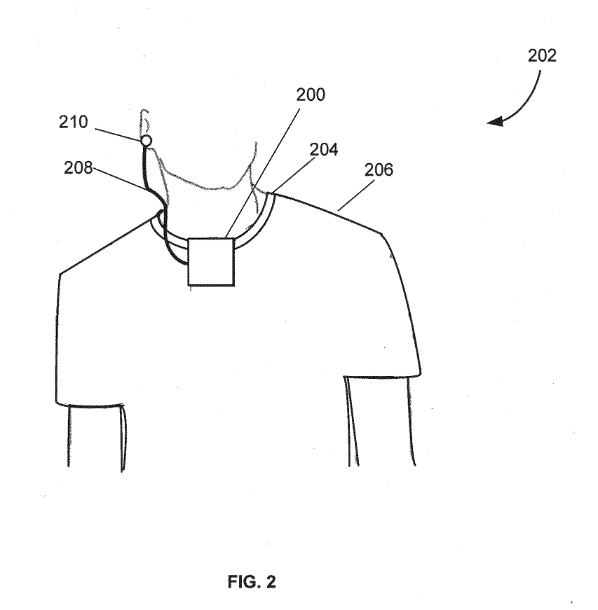

In FIG. 2, a drawing illustrates attachment of an enclosure 200 to the user 202 according to one embodiment of the present invention. The enclosure 200 may be similar to the enclosure 100 shown in FIG. 1 and described in detail above. As illustrated, the enclosure 200 is attached to a collar 204 of a t-shirt 206 worn by the user 202. A headphone wire 208 connects the enclosure 200 to an in-ear headphone speaker 210 (also referred to herein as a personal audio output communicator). The wire 208 is preferably a short-length wire so as to avoid tangling or other nuisances during sleep.

FIG. 3 illustrates a schematic diagram of a body position influencer 300 according to one embodiment of the present invention. The body position influencer 300 includes an enclosure 302 for housing the various electronic components of the body position influencer 300 and a personal audio output communicator 304 for enabling the user to listen to a user-selected stimulus, e.g., a pre-recorded audio message, designed to influence the user to change body position. The enclosure 302 may be similar to the enclosure 100 show in FIG. 1 and described in detail above. The personal audio output communicator 304 may be the headphone 210 illustrated in FIG. 2. Alternatively, the personal audio output communicator 304 may be an ear piece, an earphone, an ear bud, an in-ear headphone, or any other headphone or personal speaker. Audio may be transmitted from the enclosure 302 to the personal audio output communicator 304 via audio connection 305. In one embodiment, audio connection 305 may be a headphone wire for transmitting audio data, as shown by wire 208 in FIG. 2. In another embodiment, audio connection 305 may be a wireless connection for transmitting audio data between the personal audio output communicator 304 and the enclosure 302. In this embodiment, the personal audio output communicator 304 may be a wireless headphone device for wirelessly receiving audio signals, and the enclosure 302 may include a wireless transmitter (not shown) for wirelessly transmitting data and/or audio signals. As an example, the wireless headphone device may be a Bluetooth headset capable of receiving short wavelength radio transmissions from a Bluetooth radio embedded in the enclosure 302. Alternatively, the enclosure 302 may have an external Bluetooth radio in the form of a Bluetooth adapter connected to a USB port (not shown) of the enclosure 302. The personal audio output communicator 304 may be capable of either stereophonic or monophonic sound reproduction.

The enclosure 302 further includes a motion detector 306 for detecting a motion, a change in body position, or other motor activity associated with the user. The motion detector 306 may be any one of a tilt switch, an accelerometer, an actimetry sensor, or any other device capable of detecting the motion, body position, and/or motor activity of the user. Upon attaching the enclosure 302 to the user, the motion detector 306 may generate a motion signal associated with a body position of the user. The motion detector 306 may generate a motion signal each time the user changes or shifts body position. Alternatively, the motion detector 306 may generate a motion signal each time the user changes to a preset unwanted body position, e.g., a position that the user wants to avoid while sleeping, or otherwise laying down. According to an embodiment of the present invention, the motion detector 306 may be user-configurable for selecting one or more unwanted body positions, including, for example, a supine position, a prone position, a left-lateral (or side) position, or a right-lateral position. As an example, the user may be unable to sleep on their left side due to a healing wound, and for anti-snoring therapy, the user may want to avoid sleeping on their back. Accordingly, the motion detector 306 may be configured to detect both the supine position and the left-lateral position and to generate a motion signal when either of the two unwanted positions are detected. In another embodiment, the motion detector 306 may be set during manufacture to detect a particular unwanted body position, such as, for example, the supine position.

The enclosure 302 also includes a stimulus provider 308 that is adapted to receive the motion signal from the motion detector 306 and retrieve a motion signal value from the received motion signal. The motion signal value may be retrieved from the motion signal using known signal processing techniques, as will be appreciated by those skilled in the art. The motion signal value is representative of the motion signal and may include a numerical value representative of a measurement made by the motion detector 306 with respect to a body position, or a change in body position, of the user. Alternatively, the motion signal value may indicate whether or not the user has moved to the preset unwanted body position.

Upon retrieving the motion signal value from the received motion signal, the stimulus provider 308 may compare the motion signal value to one or more preset motion signal values that are stored in a memory 310 of the stimulus provider 308. The memory 310 may include, without limitation, any one or a combination of volatile memory elements (e.g., RAM) and nonvolatile memory elements (e.g., ROM, hard drive, tape, etc.). The preset motion signal values represent preset unwanted body positions. As discussed above, in one embodiment, the motion detector 306 may be configured to detect one or more user-selectable unwanted body positions. According to this embodiment, the memory 310 may include a motion signal database 312 for storing a corresponding motion signal value for each user-selectable unwanted body position. Once the motion detector 306 is configured by the user to detect one or more unwanted body positions, the motion detector 306 may provide the one or more user-selected unwanted body positions to the stimulus provider 308. The stimulus provider 308 may then designate as a preset motion signal value each of the motion signal values respectively associated with the one or more user-selected unwanted body positions. For example, if the user configures the motion detector 306 to detect the supine position, the stimulus provider 308 may designate the motion signal value associated with the supine position as the preset motion signal value to be used for comparison against the received motion signal.

After comparing the received motion signal value to the preset motion signal value, the stimulus provider 308 will determine whether the values match. If the retrieved motion signal value does not match the preset motion signal value, the stimulus provider 308 determines that the user has not moved into an unwanted body position and waits until it receives another motion signal from the motion detector 306 to start the comparison process again. If the stimulus provider 308 determines that the motion signal value matches the preset motion signal value, the stimulus provider 308 transmits a user-selected stimulus to the personal audio output communicator 304 to influence the user to change body position. The user-selected stimulus or voice command stimulus may be stored in the memory 310 of the stimulus provider 308. The memory 310 may be configured to store one or more stimuli. The stimulus may include, but is not limited to, one or more of a voice command, an audio recording, a music recording, and a mechanical vibration. According to one embodiment, the memory 310 is configured to store up to 5 audio messages, each message lasting up to 7 seconds. The voice commands may be recorded by the user, their bed partner, or may be preexisting voice commands, such as by known voice to the public, such as a famous movie star, news anchor person, talk show host, comedian or other known voice.

The stimulus provider 308 may include an audio output 314 for outputting the user-selected stimulus to the personal audio output communicator 304 in response to a determination that the user has moved to an unwanted body position. The audio output 314 may output audio to the personal audio output communicator 304 via the headphone wire 305. As described with reference to FIG. 1, the audio output 314 may include a female-ended audio connector for receiving a male-ended audio connector of the personal audio output communicator 304. In an alternative embodiment, the audio output 314 may include a Bluetooth radio for receiving and transmitting audio signals via short wavelength radio transmissions, and the personal audio output communicator 304 may be a Bluetooth headset adapted to receive Bluetooth radio transmissions. The stimulus provider 308 may also include a volume controller 316 for controlling the volume of the user-selected stimulus being outputted to the personal audio output communicator 304.

The stimulus provider 308 may further include an audio recorder 318 for recording a personal audio message to be used as the user-selected stimulus. The audio recorder 318 may receive the personal audio message from a microphone 320 included in the enclosure 302. When the user activates the audio recorder 318, e.g., by pressing the record switch 112 shown in FIG. 1, the microphone 302 detects sound waves produced by the user and converts the sound waves into an electric audio signal that may be stored in the memory 310 and used as the user-selected stimulus for the purposes of the present invention. For example, the personal audio message may be a voice command that includes one or more of the user's own voice, the voice of the user's bedpartner, and any other familiar voice. Alternatively, the personal audio message may be a music recording, an audio recording, or any other sound recording. In one embodiment, the personal audio message is a voice command including the voice of the user's bedpartner saying “ROLL OVER, PHIL, YOU'RE SNORING, ROLL OVER.” In another embodiment, the personal audio message is an audio file downloaded from a computer, using a wired or wireless connection, and includes, for example, any of a clip from a song, a clip from a movie's soundtrack, a recording of a famous voice, and the like.

According to one embodiment, the audio recorder 318 may record and store multiple audio messages. If the user does not respond or change positions in a specified amount of time, the audio message and/or voice volume level may be varied to help influence the user to change body position. For example, the audio message may be continuously repeated if the user does not respond by changing body position. As another example, the volume level of the audio message may be automatically increased each time the audio message is repeated. The system may also use an auto-shut-off timer to conserve power in the event the user does not respond or change position or if the device is removed and set down onto a table in the activated position. The software will monitor the number times the voice command message is repeated and if no movement response occurs after a preset number of time the device will automatically shut down.

In one embodiment, the motion sensor 306 is an actimetry sensor, or an actigraph unit, that measures the user's gross motor activity using, in part, a piezoelectric accelerometer. When attached to the user's body or clothing, the actimetry sensor 306 is able to detect body movements during sleep and determine sleep patterns. In accordance with the present invention, the actimetry sensor 306 may detect an unwanted body position of the user and transmit a motion signal to the stimulus provider 308 for processing.

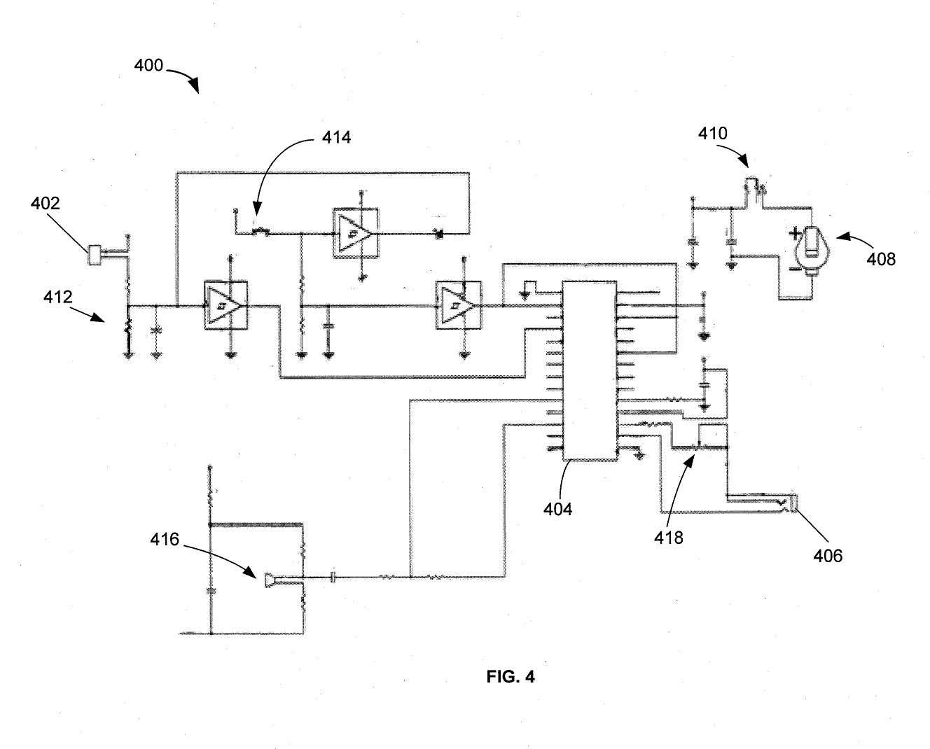

FIG. 4 shows a schematic diagram of a circuit that may be included in a body position influencer 400 according to one embodiment of the present invention. In FIG. 4, the motion sensor 402 is a tilt switch 402, also known as a mechanical gravity tip-over switch, that electrically closes, e.g., becomes a closed circuit, at a preset angle of tilt, and thereby detects a corresponding body position of the user. In one embodiment, the tilt switch 402 may be set to electrically close at a 45 degree tilt, which corresponds to the user lying in the supine position. Using the exemplary views of the enclosure 100 illustrated in FIG. 1, the tilt switch 402 detects a 45 degree tilt, and thereby, a supine position, when the enclosure 100 is in the position of open view 118, where the front 102 is facing up and away from the user and the back 116 is facing down and towards the user. According to one embodiment, the tilt switch 402 may be hardwired into one fixed position, so that the tilt switch 402 electrically closes only when the user is in a preselected position, such as, for example, the supine position. In an alternative embodiment, the tilt switch 402 may be mounted in four different positions to allow for four mechanically selectable tilt angles, each corresponding to a possible body position. The mechanically selectable tilt switch 402 may be mounted on an armature that allows the tilt switch 402 to rotate in a 360 degree radius and may include a correspondingly rotatable external knob with an arrow pointer for the user to select a body position that the user wants to avoid while sleeping, or otherwise lying down. In one embodiment, the tilt switch 402 may be a PBS070310 type tilt switch. Alternatively, the tilt switch 402 may be any other type of tilt switch, as will be appreciated by those skilled in the art.

Referring still to FIG. 4, the tilt switch 402 may be electrically coupled to a stimulus provider 404. In the illustrated embodiment, the stimulus provider 404 includes an integrated chip (IC) adapted to record and/or playback audio. For example, the IC may be a NUVOTON ISD18B12 chip, or any other IC suitable for carrying out the audio recording and playback features of the present invention. Once the tilt switch 402 transmits a motion signal indicating that the user has moved to an unwanted body position, e.g., once the tilt switch is electrically closed, the stimulus provider 404 may begin playback of the user-selected stimulus through an audio output 406. The tilt switch 403 may also be electrically coupled to a battery 408, such as, for example, a three-volt lithium battery, for providing power to the illustrated circuit. The battery 408 may be held in place on the circuit board by a battery holder socket. The battery 408 may be electrically coupled, in series, with a power switch 410. The power switch 410 allows the user to turn power to the illustrated circuit on or off.

When the tilt switch 402 is electrically closed, the battery 408 may supply the motion signal, e.g., an electric current, across the closed tilt switch 402 to the stimulus provider 404, thus activating the stimulus provider 404 and beginning playback of the user-selected stimulus through an audio output 406. In some cases, the user may, for example, temporarily move to the unwanted body position while in the process of changing body position while sleeping. To safeguard against such false triggers, the tilt switch 402 is electrically coupled to a resistor-capacitor (RC) network 412 to delay activation of the stimulus provider 404.

As long as the tilt switch 402 stays closed, the stimulus recorder 404 will continue to playback the user-selected stimulus through the audio output 406, thus creating a playback loop. This playback loop will stop, e.g., the tilt switch 402 will open and the user-selected stimulus will stop playing, once the user is influenced to change his position. The RC network 412 also acts as a filter to delay the end of the playback loop once the tilt switch 402 is opened, in case the user only partially changes body position and/or shifts slightly but does not complete the change in body position.

The user may press a record switch 414 to activate audio recording by the stimulus provider 404, the record switch 414 being electrically coupled to the stimulus provider 404. In one embodiment, the stimulus provider 404 may be capable of recording one message at a time, up to 7 seconds long. The stimulus provider 404 is electrically coupled to a microphone 416 that is capable of obtaining audio signals with good sensitivity, even if the enclosure lid is closed (as shown in FIG. 1). The microphone 416 may be a condenser style microphone, or any other type of microphone suitable for use with the features of the present invention. Once the record switch 410 is released, the stimulus provider 404 will deactivate the recording process and return to a “wait” mode, where the stimulus provider 404 waits for a motion signal that is associated with an unwanted body position. The stimulus provider may also be electrically coupled to a volume controller 418 for adjusting a volume level of the audio outputted through the audio output 406 to the personal audio output communicator 304 shown in FIG. 3.

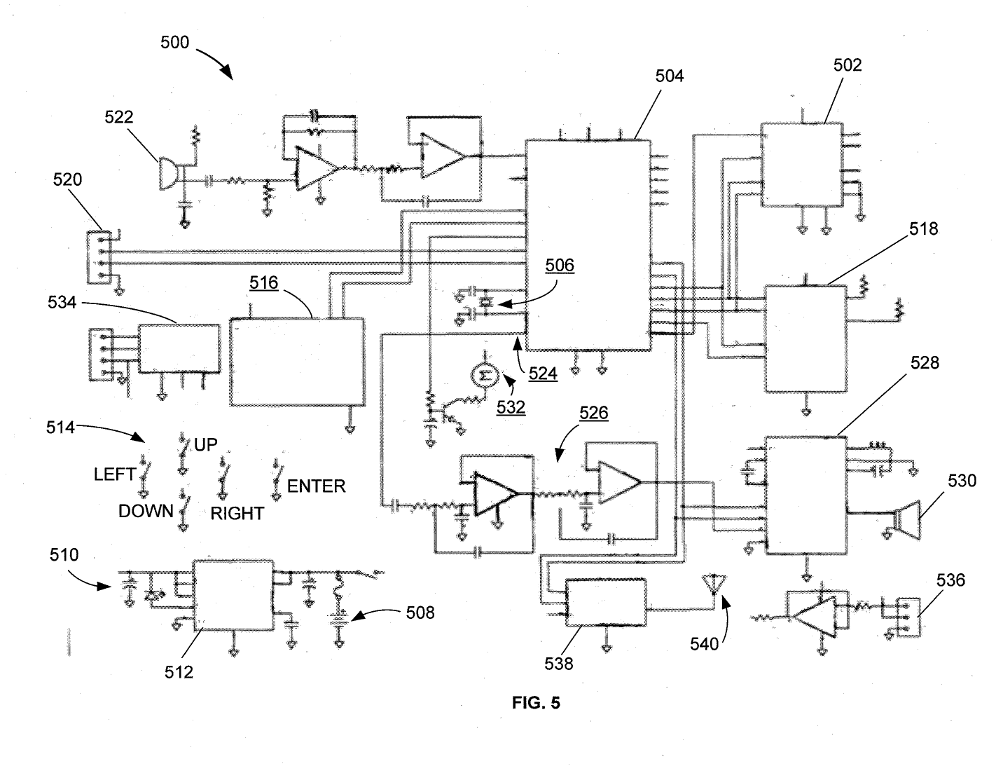

FIG. 5 illustrates a schematic diagram of a circuit that may be included in a body position influencer 500 in accordance with an embodiment of the present invention. In FIG. 5, a motion detector 502 is an accelerometer 502 capable of electronically detecting the user's body position in a 360 degree radius and outputting a detected body position using X, Y, Z coordinates. The accelerometer 502 may include a ADXL345Z model accelerometer, or the like.

According to the illustrated embodiment, the accelerometer 502 is electrically coupled to a stimulus provider 504. The stimulus provider 504 may be a microprocessor chip, such as, for example, a MicroChip PIC24 series device that uses an 8 MHz internal RC oscillator to execute software code. Alternatively, the microprocessor 504 may be any other type of microprocessor capable of carrying out the features of the present invention. The microprocessor 504 may cycle between active and inactive states using an internal timer in order to conserve power during operation. For example, the internal timer may be set to activate the microprocessor 504 at set time intervals, such as, e.g., every 2 to 4 seconds. The microprocessor 504 and the accelerometer 502 operate in a master/slave configuration. During an active time cycle, the microprocessor 504 may turn on its internal oscillator and request a motion signal from the accelerometer 502. The microprocessor 504 may then process the motion signal to determine whether the user has moved to an unwanted body position. The microprocessor 504 may also be electrically coupled to an external oscillator crystal 506 operating on, for example, a 32.768 Khz frequency. If the microprocessor 504 determines that the received motion signal is not indicative of an unwanted body position, the microprocessor 504 may activate the external oscillator 506 and enter an inactive state to reduce current draw while waiting for the next active time cycle.

The microprocessor 504 is also electrically coupled to a battery 508 that provides power throughout the body position influencer 500. The battery 508 may be a rechargeable Li-Polymer battery, or the like. The battery 508 may be charged through a USB port 510 that is electrically coupled to the microprocessor 504. The USB port 510 may be configured to receive power from an external source, such as, for example, a conventional AC/DC adapter plug connected to a power outlet or a USB cable connected to a computer. The charge regulation may be provided a charging circuit 512, such as, for example, a MCP73853 model charger. The charging circuit 512 monitors the charge capacity of the battery 508, so as to avoid over-charging the system.

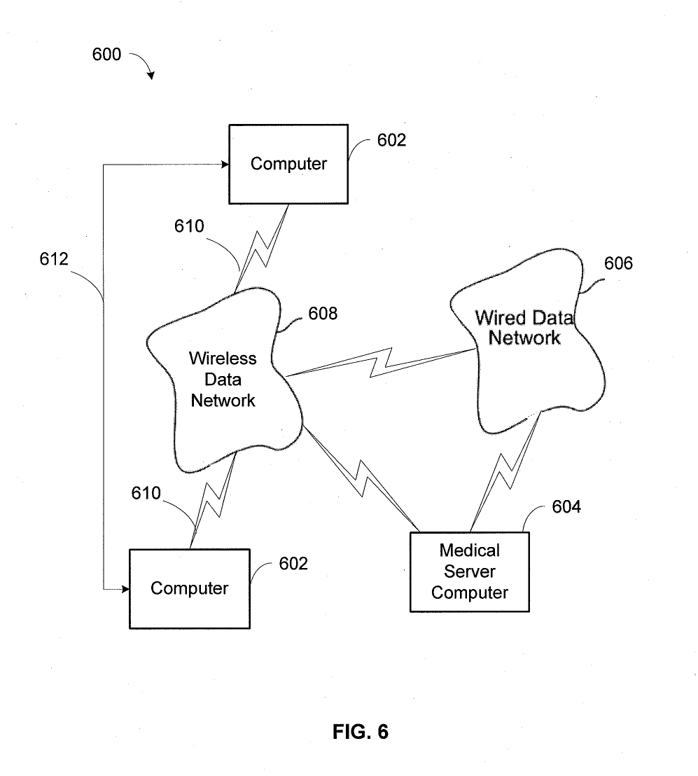

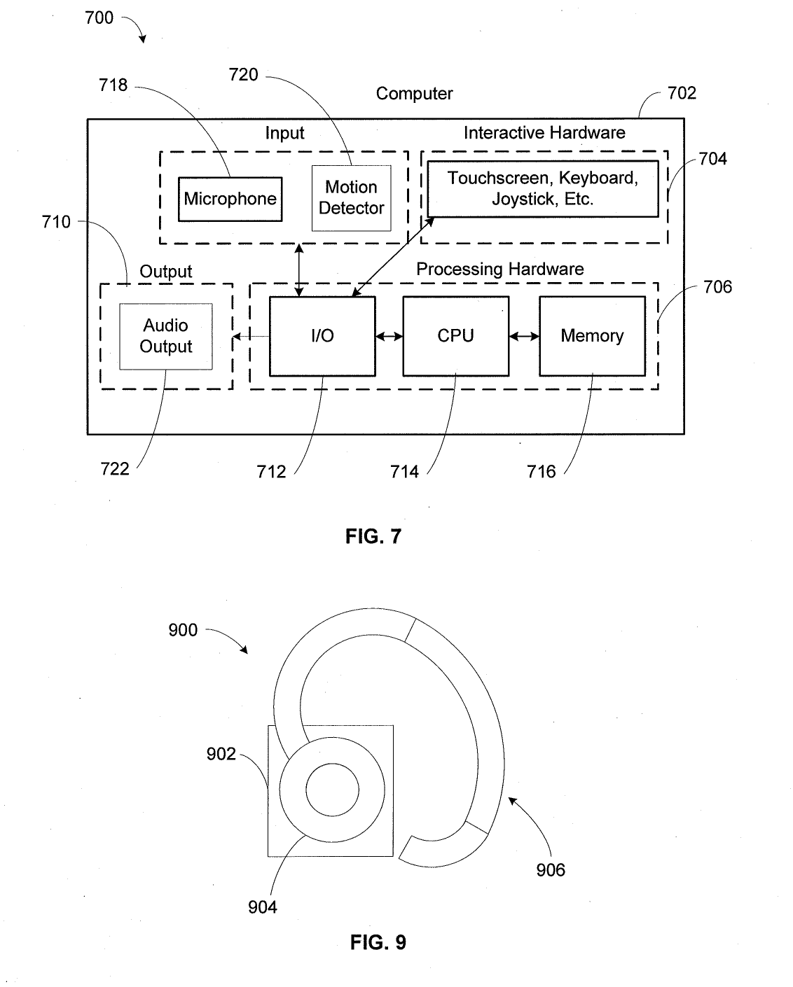

As illustrated, the microprocessor 504 is electrically coupled to control switches 514, a display unit 516, and a memory 518. Using the control switches 514 and the display unit 516, the user may electronically select which body positions to avoid while sleeping. Selected body positions may be stored in the memory 518. The display 516 may be an LCD display that serves as a user interface for controlling various functions of the body position influencer 500. Control switches 514 may be labeled UP, DOWN, LEFT, and RIGHT and may be used to control data entry and various parameters, including, for example, any one or a combination of date, time, activation delay, snooze, hours slept, body positions, and battery status. The memory 518 may store any parameters and data entered by the user. According to one embodiment, the body position influencer 500 may be externally controlled by electrically coupling a USB serial port 520 of the body position influencer 500 to a computer, a wireless mobile personal computer, or the like and using a body position influencer application or software program stored on the computer (to be discussed in more detail with reference to FIGS. 6 and 7).

As illustrated, the body position influencer 500 may include a microphone 522 that is electrically coupled to the microprocessor 504. Microphone 522 may be used to capture and transmit an audio signal to the microprocessor 504 for audio signal processing. The microprocessor 504 may include analog-to-digital converter software for transforming the audio signal into a digital format. The digital audio signal may be stored in the memory 518 and used as a personal audio message for influencing the user to change body position in accordance with the present invention. The memory 510 may store multiple audio messages with varying lengths of record time. Using, for example, the control switches 514 and the display 516, the user may be able to select which of the recorded audio messages should be played when an unwanted body position is detected. In one embodiment, the user may select a different audio message for each unwanted body position. In another embodiment, the user may select playback of a series of audio messages, rather than repeating playback of a single audio message, in situations where the first user-selected stimulus does not successfully influence the user to change positions. The microprocessor 504 may include an audio recording application or software program for carrying out the audio recording features described herein.

Once the microprocessor 504 determines that the accelerometer 502 has detected an unwanted position, the user-selected stimulus, or personal audio message, may be played through an output 524 of the microprocessor 504. The output 524 is electrically coupled to a low-pass amplifier circuit 526 designed to filter the pulse width modulated audio signal transmitted by the output 524 and to generate an analog audio signal representative of the recorded audio message. The personal audio message may then be transmitted to a headphone amplifier 528, where the user may hear the audio message using a headphone 530. The sound level of the outputted audio message may be controlled by a volume controller included in the headphone amplifier 528. According to the present invention, the sound level of the user-selected stimulus may need to be varied to help influence the user to change positions while sleeping. For example, the sound level of the audio message may slowly get louder with time to assist with inducing the sleeper to rollover and/or change their sleeping position.

According to one embodiment, the body position influencer 500 may include a vibrator shaking component 532 (also referred to herein as a mechanical vibrator) to be used as an additional influence device in tandem with the use of the pre-recorded audio message and adjustable volume control to help persuade the user to roll over. The mechanical vibrator 532 may be activated in conjunction with the audio messages in the event that the user is not responding to the audio messages. The mechanical vibrator 532 may be mounted in the enclosure 100 against the user's skin to maximize the vibration effect against the body.

According to one embodiment, the body position influencer 500 may include a pulse oximeter circuit 534 for measuring the user's oxygen level and verifying the effectiveness of the body position influencer. The pulse oximeter 534 may be, for example, a NONIN OEM III pulse oximeter module, or the like. The pulse oximeter 534 uses an external photo diode and light emitting diodes to measure blood oxygen levels and heart rate. Data associated with the measured oxygen levels may be recorded and stored in the memory 518 of the microprocessor 504. The recorded oxygen level data may be used to specify which body positions may pose a problem and therefore, should be avoided, and which body positions are most effective for eliminating snoring, or other issues. The recorded oxygen level data may also be used in conjunction with the recorded body position data described above to prove usage of the body position influencer for compliance with physician instructions or insurance protocols.

The pulse and oxygen levels can also be used to monitor the effectiveness of combination therapy when using the body position influencer with an oral appliance, as described above. The recording of data can also assist the physician in calibrating the oral appliance device and sleeping position providing effectiveness of the combination therapy.

In one embodiment of the present invention, breathing straps 536 may be connected to the microprocessor 504 to monitor chest and abdomen movement. The breathing straps 536 can also be incorporated into the attachment mechanism for attaching the body position influencer to the user's body. The microprocessor 504 may record and monitor breathing movement to assist in effectiveness of the system. The accelerometer 502 may also be used to detect chest cavity movement in a manner similar to the resistive chest straps. The accelerometer 525 may include a combination gyro version that can also detect gravity changes and provide a digital signal representative of the change in position of the chest cavity, thus providing air flow data. This method can provide important information for system and respiratory effectiveness.

In one embodiment, the microprocessor 714 may record a plurality of motion signal values associated with a respective plurality of predetermined time values. For example, the microprocessor 504 may store data related to the body position of the user at set time intervals, e.g., 2-4 seconds throughout the night. This sleeping information may be used to verify proper operation of the device and may be downloaded into a computer or smart phone and sent to the primary physician hosting web site via the Internet using a hardwired connection, e.g., through the USB port 520, or a wireless connection, e.g. using an internal wireless module 538 and a wireless antenna 540. The wireless module 538 may use WIFI, BLUETOOTH, ZIGBEE, or any other wireless technology, to transfer the user's information to the Internet.

The microprocessor 504 may also monitor compliance by detecting expected body movement throughout the night using the accelerometer 502. This information is used to verify that the user is actually wearing the device and proves compliance. This information may be used by insurance companies to prove the patient is actually using the device. The compliance data may also be sent to a computer or smart phone as described above and with reference to FIG. 6.

In another embodiment, as mentioned above, the system and method can include a personal body positional monitor is adapted to be attached to the user, and includes a motion detector for generating a motion signal associated with a body position of the user. The personal positional monitor can include a processor, a memory, and program code for receiving signals from the motion detector and for determining position and for recoding the position of the user while the user is sleeping. This embodiment need not include any aspect of therapy, or may include preventative therapy as described herein. As mentioned above, the recorded information can be used to verify that the user is actually wearing the device, prove compliance of the user relative to a therapy, monitor compliance of a nurse's responsibilities to shift patients in bed to prevent bed sores, make sure a patient does not move into a certain position, provide and/or determine the effectiveness of the therapy. This information may be used by insurance companies to prove the patient is actually using the device. This compliance/monitoring data may be sent to a computer and memory via direct connection or wirelessly. The computer can then make this information available through a client interface to a website or via download to a Smartphone App, that presents such information to physicians and/or patients through an electronic interface device, as described above and with reference to FIG. 6. A live monitoring computer/service, including appropriate program code, can be connected to the personal body positional monitor for making one of more of the above determinations on a real time basis and to provide the ability for immediate feedback to the user and/or care-giving personnel.

According to one embodiment, the body position influencer may include an activation delay setting that allows the user to selectively delay activation of the body position influencer for a preset amount of time. For example, the user may decide to lie on their back or other selected position for 30 minutes before going to sleep, in order to read a book, watch TV, etc.

FIGS. 6 and 7 illustrate an embodiment in which the body position influencer is adapted to be incorporated into a computer, such as, for example, a wireless mobile personal computer, a smart phone, or the like. In this embodiment, the body position influencer may include an application software that utilizes the computer's hardware to perform the operations of the present invention. The body position influencer application may perform one or more of the functions described above, including wirelessly connecting to a physician's or insurance company's website to allow for downloading of stored sleep position data, compliance data, and effectiveness information.

Referring now to FIG. 6, a system diagram illustrates an embodiment of a computer networked system 600 for influencing a change in body position using a computer, such as a wireless mobile personal computer. In one embodiment, the computer networked system 600 includes a plurality of computers 602, a medical server computer 604, a wired data network 606, and a wireless data network 608. The wired data network 606 can be a global network, a wide area network, or a local area network. The wireless data network 608, which can couple to the wired data network 606, can include one of more wireless data networks, such as cellular networks, WiFi networks, Bluetooth networks, etc. The medical server computer 604 can couple to both the wired data network 606 and the wireless data network 608. The computers 602 can couple to the wireless data network 608 over wireless links 662. In this regard, the computers 602 can send body position data and other related medical data collected in accordance with the present invention to each other and/or to the medical server computer 604 through the wireless data network 608. The wired data network 606 and the wireless data network 608 pertain to some portions of the World Wide Web (WWW, hereafter referred to as Web) and the Internet.

Now referring to FIG. 7, a diagram 700 illustrates schematically one of the computers 602 of FIG. 6. The illustrated computer 702 is preferably a handheld digital device of palm size or smaller, and can be a personal digital assistant (PDA), a cellular phone, a hybrid between a cellular phone and a PDA, a smart phone such as an iPhone (3G, 3GS, 4, 4S, or other versions), or any other handheld electronic device having a display screen. The computer 702 includes an interactive hardware portion 704, a processing hardware portion 706, an input portion 708, and an output portion 710. The interactive hardware portion 704 can include one or more of a touch screen, a keyboard, a stylus, a joystick, and the like, which can be arranged in various manners and have different shapes without changing the spirit of the interaction of the hardware portion 704 with an I/O portion 712. The touch screen can be a liquid crystal display (LCD), display screen, a plasma screen, a light emitting diode (LED), or any other screen capable of displaying text and images. The input portion 708 can include one or more of a microphone, a motion detector, and the like, which can be arranged in various manners and have different shapes without changing the spirit of the interaction of the input portion 708 with the I/O portion 712.

The processing hardware portion 706 includes the input/output (I/O) portion 708, a central processing unit (CPU) portion 714, i.e., a microprocessor, and a memory 716. The CPU portion 714 can be any computer-processing unit from a singular microchip to extensive microchip configurations. The memory portion 716 can include, without limitation, any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory portion 716 may incorporate electronic, magnetic, optical, and/or other types of storage media, and can have a distributed architecture where various components are situated remotely from one another, but are still accessed by the microprocessor portion 714. The interactive hardware portion 704 and the input portion 708 are coupled to the I/O portion 712 such that a command, an audio signal, a motion signal, or other input entered or provided by a user through the interactive hardware portion 704 or the input portion 708 will be forwarded to the I/O portion 708, to the processor portion 714, and then to the memory portion 716.

The computer 702 may include one or more executable programs, including, but not limited to, a body position influencer application or computer software program, a wireless network communication software application, and a touch screen browser software application. Each of the executable programs may be stored within the memory portion 716 or other computer hardware device, for operating in connection with the microprocessor portion 714 or other hardware device. The executable programs may be implemented in software, firmware, hardware, or a combination thereof.

When the computer 702 is in operation, the CPU portion 714 is configured to execute software stored within the memory 716, to communicate data to and from the memory 716, and to generally control operations of the computer 702 pursuant to the software. The body position influencer application may be read by the CPU portion 714 and then executed. When body position influencer application is implemented in software, it can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The body position influencer application can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. In another embodiment, where the desired product optimization application 318 is implemented in hardware, it can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As discussed above, each one of the computers 705 may include a touch screen browser software application. In one embodiment, the touch screen browser application is provided for displaying one or more user-configurable options associated with the body position influencer application and receiving user selections in response thereto.

As discussed above, the microprocessor 714 may record the body position of the user at set time intervals and store this data in the memory 716. The stored body position data may then be transferred via a hardwire connection, such as a USB port, to a computer 602 or via a wireless connection, such as over the wireless connection 612, to a wireless data network 608 and then to a medical server computer 604 to be read by a doctor or insurance company to verify effectiveness and compliance.

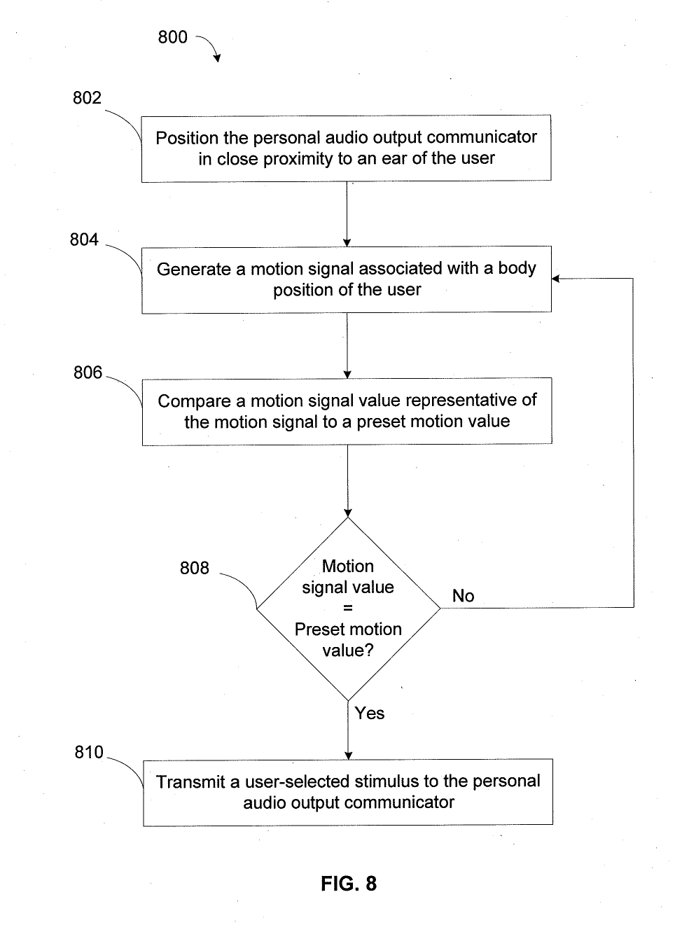

FIG. 8 is a flow chart showing one embodiment of a method 800 for influencing body position in accordance with the present invention. Certain method steps may be carried out by the body position influencer application described above. The method 800 begins at step 802 where the personal audio output communicator is positioned in close proximity to an ear of the user, so that the audio outputted by the personal audio output communicator is not audible to persons other than the user. For example, the personal audio output communicator may be an in-ear headphone that is positioned in the ear of the user. At step 804, a motion signal associated with a body position of the user is generated. At step 806, a motion signal value representative of the motion signal is compared to a preset motion value. At step 808, a determination is made as to whether the motion signal value equals the preset motion value. If the determination is “no”, the method 600 returns back to step 604, where another motion signal is generated in association with a body position of the user. This loop will continue until a determination is made at step 808 that the motion signal value equals the preset motion value. Once the determination at step 808 becomes a “yes”, a user-selected stimulus is transmitted to the personal audio output communicator for influencing the user to change body position.

FIG. 9 illustrates a side view of one embodiment of the present invention in which the body position influencer 900 may be adapted to be housed in and/or around an earphone, earpiece, in-ear speaker, or the like. According to this embodiment, the user may wear the body position influencer 900 in their ear, like a hearing aid, thus allowing for a custom in-ear configuration. In the illustrated embodiment, the body position influencer 900 may include a stimulus provider 902, a personal output communicator 904, and an attachment clip 906. The stimulus provider 902 may be coupled to the attachment clip 906 and/or the personal audio output communicator 904. In accordance with one or more embodiments described in more detail above, the stimulus provider 902 may be adapted to include one or more of a motion sensor for detecting a body position of the user, a microphone for recording an audio message, a microprocessor for storing and playing back the audio message, a volume controller for controlling the volume level at which the audio message is being played, an audio output for transmitting the audio message to the personal audio output communicator, and/or a mechanical vibrator for providing another stimulus to influence the user to change body position. The personal audio output communicator 904 may include an earphone, an ear bud, an ear piece, or the like. The attachment clip 906 may be attached to an external portion of the ear, or the outer ear. For example, the attachment clip 906 may be fitted around the back of the outer ear.

Any process descriptions or blocks in figures, such as FIG. 8, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. An electronic device for influencing a user to change and improve body position, comprising:
a personal audio output communicator adapted to be positioned in close proximity to an ear of the user to prevent the audio outputted by the personal audio output communicator from being audible to persons other than the user;
a motion detector adapted to attach to the user for generating a motion signal associated with a body position of the user; and
a stimulus provider adapted to:
receive the motion signal from the motion detector,
compare a motion signal value representative of the motion signal to a preset motion value, the preset motion value being associated with an unwanted change in body position, and
in response to the comparison, transmit at least one of a user-selected stimulus or voice command to the personal audio output communicator for influencing the user to change body position.

2. The electronic device of claim 1, further comprising:
an audio recorder for recording a user-specified audio message; and
a memory for storing the recorded audio message.

3. The electronic device of claim 2, wherein the voice command directs the user to change body position.

4. The electronic device of claim 3, wherein the voice command directs the user to change body position is a voice familiar to the user.

5. The electronic device of claim 1, wherein the motion detector is an accelerometer for measuring an acceleration value associated with a body position of the user, the acceleration value being used to compare against the preset motion value.

6. The electronic device of claim 1, wherein the motion detector is a tilt switch that electrically closes at a preset angle of tilt, the preset angle of tilt being selected to correspond with the unwanted change in body position, wherein the motion signal generated by the tilt switch is representative of whether the tilt switch is open or closed.

7. The electronic device of claim 1, wherein the preset motion value is user-selectable to correspond with one or more unwanted body positions.

8. The electronic device of claim 1, further comprising a memory for recording a plurality of motion signal values associated with a respective plurality of predetermined time values.

9. The electronic device of claim 1, wherein the personal audio output communicator comprises a headphone.

10. The electronic device of claim 1, wherein the electronic device is adapted to connect to the ear of the user.

11. A method for influencing a user to change and improve body position using an electronic device having a personal audio output communicator, a motion detector, and a stimulus provider, the method comprising:
positioning the personal audio output communicator in close proximity to an ear of the user to prevent the audio outputted by the personal audio output communicator from being audible to persons other than the user;
generating a motion signal associated with a body position of the user;
comparing a motion signal value representative of the motion signal to a preset motion value, the preset motion value being associated with an unwanted change in body position; and
in response to the comparison, transmitting at least one of a voice command stimulus to the personal audio output communicator, the voice command stimulus influencing the user to change body position.

12. The method of claim 11, further comprising attaching the motion detector to the user.

13. The method of claim 11, furthering comprising:
recording a user-specified audio message; and
storing the recorded audio message in a memory of the electronic device.

14. The method of claim 13, wherein the voice command directing the user to change body position is a voice familiar to the user.

15. The method of claim 11, further comprising the step of recording a plurality of motion signal values associated with a respective plurality of predetermined time values.

16. The method of claim 11, wherein attaching the motion detector to the user includes attaching the motion detector to an article of clothing.

17. The method of claim 11, wherein attaching the motion detector to the user includes fastening a strap around a chest of the user; and
attaching the motion detector to said strap.

18. An electronic device for influencing a user to change and improve body position, comprising:
a personal audio output communicator adapted to be positioned in close proximity to an ear of the user to prevent the audio outputted by the personal audio output communicator from being audible to persons other than the user; and
a stimulus provider adapted to transmit a user-selected stimulus and/or voice command to the personal audio output communicator for influencing the user to change body position in response to a detected body motion.

19. A mobile telephone adapted to include the electronic device of claim 18.

20. A computer for influencing a user to change and improve body position, the computer comprising a processor, a motion detector, and a memory comprising a body position influencer application and a database, the processor in communication with a personal audio output communicator that is positioned in close proximity to an ear of the user for preventing the audio outputted by the personal audio output communicator from being audible to persons other than the user, the body position influencer application being configured to:
generate a motion signal associated with a body position of the user;
compare a motion signal value representative of the motion signal to a preset motion value, the preset motion value being associated with an unwanted change in body position; and
in response to the comparison, transmit a user-selected stimulus and/or a voice commend to the personal audio output communicator, the stimulus influencing the user to change body position.

21. A computer for monitoring a user's body position for monitoring compliance with a healthcare objective, the computer comprising a processor, a motion detector, and a memory comprising a monitoring application and a database, the monitoring application being configured to:
generating a plurality of motion signals associated with various positions of the user;
receiving a plurality of motion signal values representative of the plurality of motion signals,
determining a plurality of positions of the user from the plurality of motion signal values;
storing the plurality of positions of the user;
comparing the plurality of positions of the user to an healthcare objective; and,
determining and transmitting whether the healthcare objective has been met.

22. The computer of claim 21 wherein the stored plurality of positions is transmitted to a remote server for viewing through a client device, and wherein the healthcare objective is at least one of verifying that the user is actually wearing the computer, determining whether a therapy is effective, determining whether a caregiver is performing their tasks relative to the user, and/or determining whether a user is not moving into a certain body position.
